(19) United States
(12) Patent Application Publication
(10) Pub. No.: US 2026/0131596 A1
(43) Pub. Date: May 14, 2026

(54) DEFORMABLE WHEEL

(71) Applicant: Stéphane Bourgoin, Baie-Comeau (CA)

(72) Inventor: Stéphane Bourgoin, Baie-Comeau (CA)

(21) Appl. No.: 18/946,015

(22) Filed: Nov. 13, 2024

(51) Int. Cl. B60B 19/04; B60C 7/14

(52) U.S. Cl. CPC B60B 19/04; B60C 7/146; B60B 2900/70

(57) ABSTRACT

A deformable wheel, comprising a hub; a deformable tread surrounding the hub spaced apart therefrom; and a plurality of spokes extending between the hub and the tread, each spoke being secured to the tread at a respective tread-to-spoke attachment location and to the hub at a respective hub-to-spoke attachment location, each spoke being movable between a first configuration wherein the respective tread-to-spoke attachment location is closest to the respective hub-to-spoke attachment location and a second configuration wherein the respective tread-to-spoke attachment location is furthest from the respective hub-to-spoke attachment location. The spokes are configured and sized and operatively coupled to each other so that the tread maintains a single predetermined elongated shape by varying a tread-to-hub distance between each of the pairs of respective tread-to-spoke and hub-to-spoke attachment locations as the spokes are moved between the spoke first and second configurations.

### FIELD OF THE INVENTION

The present invention relates to the general field of transportation, and is more particularly concerned with a deformable wheel.

### BACKGROUND

Many vehicles are used off-road, on unpaved surfaces. Such surfaces may be uneven or relatively soft, which may impede movement of the vehicle. Conventional wheels and tires are suboptimal for travelling over such terrain, as they may become stuck.

One solution to this issue is to use oversized wheels and tires. However, such oversized wheels and tires may be relatively expensive, and may be unsuitable to travail on many types of terrain, for example in densely forested areas. Also, when travelling on very soft terrain, such as snow, such wheels would need to be unpractical large to ensure that the vehicle does not get stuck. Another solution is to use tracks to replace the wheels. However, tracks may be mechanically complex and thus require relatively large amounts of maintenance. They also can damage paved surfaces.

Thus, there is a need on the market for an improved wheel. An object of the present invention is to provide such an improved wheel.

### SUMMARY OF THE INVENTION

In a broad aspect, there is provided a deformable wheel, comprising: a hub; a deformable tread surrounding the hub spaced apart therefrom; and a plurality of spokes extending between the hub and the tread, each spoke being secured to the tread at a respective tread-to-spoke attachment location and to the hub at a respective hub-to-spoke attachment location, each spoke being movable between a first configuration wherein the respective tread-to-spoke attachment location is closest to the respective hub-to-spoke attachment location and a second configuration wherein the respective tread-to-spoke attachment location is furthest from the respective hub-to-spoke attachment location; wherein the spokes are configured and sized and operatively coupled to each other so that the tread maintains a single predetermined elongated shape by varying a tread-to-hub distance between each of the pairs of respective tread-to-spoke and hub-to-spoke attachment locations as the spokes are moved between the spoke first and second configurations.

Advantageously, the proposed wheel has, in some embodiments, a relatively large footprint, which reduces the pressure exerted by the wheel on soft terrain on which the wheel rolls. This is due to its elongated shape, which is non-circular and has a shape similar to that of an ellipse or an oval.

There may also be provided a wheel wherein the spokes each include a spoke hub segment mounted to the hub at the respective hub-to-spoke attachment location and a spoke tread segment mounted to the tread at the respective tread-to-spoke attachment location, the spoke hub and tread segments being pivotally secured to each other through a pivot opposed to the tread-to-spoke and hub-to-spoke attachment locations.

There may also be provided a wheel wherein the spoke hub segment is pivotable relative to the hub and the spoke tread segment is fixedly mounted to the tread.

There may also be provided a wheel wherein the spoke tread segment is substantially perpendicular to the tread.

There may also be provided a wheel further comprising a transmission operatively coupling to each other the spoke hub segments of all the spokes so that the spoke hub segments maintain a predetermined relative angular relationship relative to each other as the spoke hub segments rotate relative to the hub.

There may also be provided a wheel wherein the transmission includes a plurality of spoke gears each jointly rotatable with a respective one of the spoke hub segments and a synchronizing gear engaging all the spoke gears to synchronize rotations of the spoke gears relative to each other.

There may also be provided a wheel wherein the synchronizing gear is freely rotatable around the hub.

There may also be provided a wheel wherein the synchronizing gear is motorized such that rotating the synchronizing gear relative to the hub rotates the spoke hub segments relative to the hub to entrain the wheel.

There may also be provided a wheel wherein the synchronizing gear is part of a rotor of an electric motor and the hub is part of a stator of the electric motor.

There may also be provided a wheel wherein the spoke tread segment is longer than the spoke hub segment.

There may also be provided a wheel wherein the pivot is located radially inwardly relative to the hub-to-spoke attachment location in the first configuration.

There may also be provided a wheel wherein the pivot is located radially outwardly relative to the hub-to-spoke attachment location in the second configuration.

There may also be provided a wheel wherein the tread includes a track.

There may also be provided a wheel wherein the tread includes a rubber outer surface.

There may also be provided a wheel wherein the rubber outer surface is corrugated.

There may also be provided a wheel wherein the tread is made of rubber.

There may also be provided a wheel wherein the hub is hollow and hermetically closed so that the wheel is buoyant.

There may also be provided a wheel wherein the wheel defines paddles for pushing against water when the wheel is immersed in the water to advance the wheel.

In another broad aspect, there is provided a deformable wheel, comprising a hub; a deformable tread surrounding the hub spaced apart therefrom; and a plurality of spokes extending between the hub and the tread, each spoke being secured to the tread at a respective tread-to-spoke attachment location and to the hub at a respective hub-to-spoke attachment location, each spoke being movable between a first configuration wherein the respective tread-to-spoke attachment location is closest to the respective hub-to-spoke attachment location and a second configuration wherein the respective tread-to-spoke attachment location is furthest from the respective hub-to-spoke attachment location; wherein the spokes are configured and sized and mechanically coupled to each other so that the tread maintains a single predetermined elongated shape when the wheel advances on a ground surface. All the other characteristics of the first broad aspect mentioned above also apply to the present broad aspect.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a perspective view, illustrates a wheel in accordance with an embodiment of the present invention;

FIG. 2, in a side elevation view, illustrates the wheel shown in FIG. 1;

FIG. 3, in top plan view with parts removed, illustrates the wheel shown in FIG. 1;

FIG. 4, in a perspective view, illustrates a wheel in accordance with an alternative embodiment of the present invention;

FIG. 5, in a perspective view, illustrates a wheel in accordance with another alternative embodiment of the present invention;

FIG. 6, in a perspective view, illustrates a wheel in accordance with yet another alternative embodiment of the present invention;

FIG. 7, in a perspective cut-away view, illustrates the wheel shown in FIG. 6.

FIG. 8, in a perspective view, illustrates a wheel in accordance with yet another alternative embodiment of the present invention;

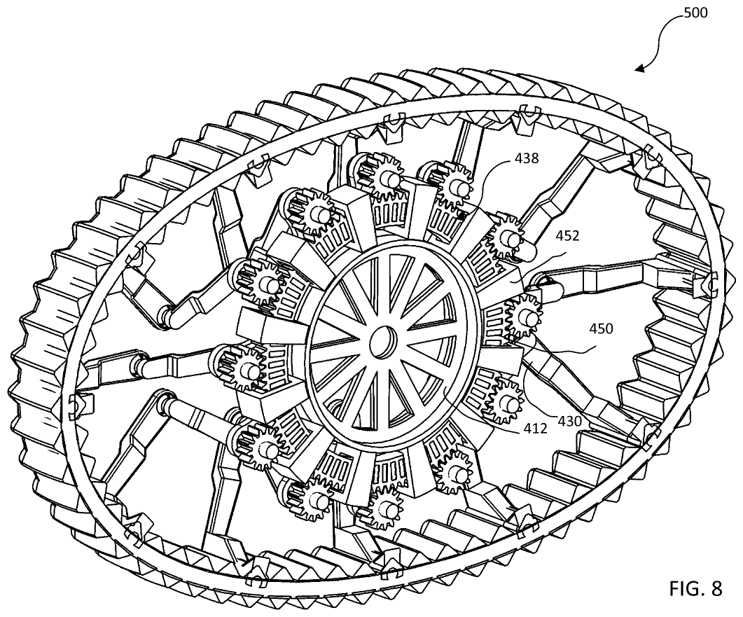

FIG. 9A, in a perspective view with parts removed, illustrates the wheel shown in FIG. 1 with spokes thereof in a first configuration;

FIG. 9B, in a perspective view with parts removed, illustrates the wheel shown in FIG. 1 with spokes thereof in a second configuration;

FIG. 9C, in a perspective view with parts removed, illustrates the wheel shown in FIG. 1 with spokes thereof in a third configuration;

FIG. 9D, in a perspective view with parts removed, illustrates the wheel shown in FIG. 1 with spokes thereof in a fourth configuration; and

FIG. 9E, in a perspective view with parts removed, illustrates the wheel shown in FIG. 1 with spokes thereof in a fifth configuration.

### DETAILED DESCRIPTION

In the present document, the terminology “substantially” is used to denote variations in the thus qualified terms that have no significant effect on the principle of operation of the proposed wheel. These variations may be minor variations in design or variations due to mechanical tolerances in manufacturing and use of the wheel. These variations are to be seen with the eye of the reader skilled in the art.

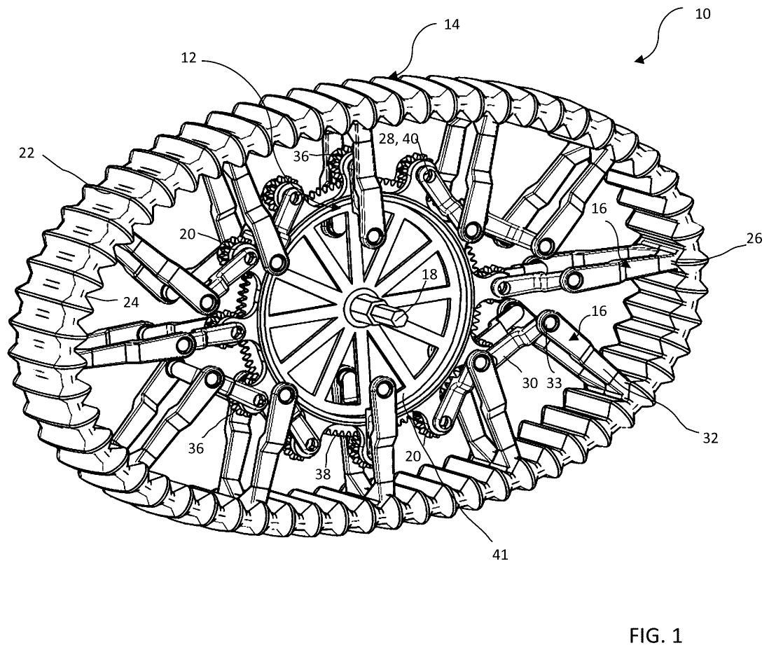

Referring collectively to FIGS. 1 to 3, there is shown a deformable wheel 10 in accordance with an embodiment of the present invention. The wheel 10 includes a hub 12, a deformable tread 14, and a plurality of spokes 16. The hub 12 is mounted to an axle 18. The axle 18 is for example, and non-limitingly, part of a vehicle (not shown in the drawings), and may be driven or freely rotatable.

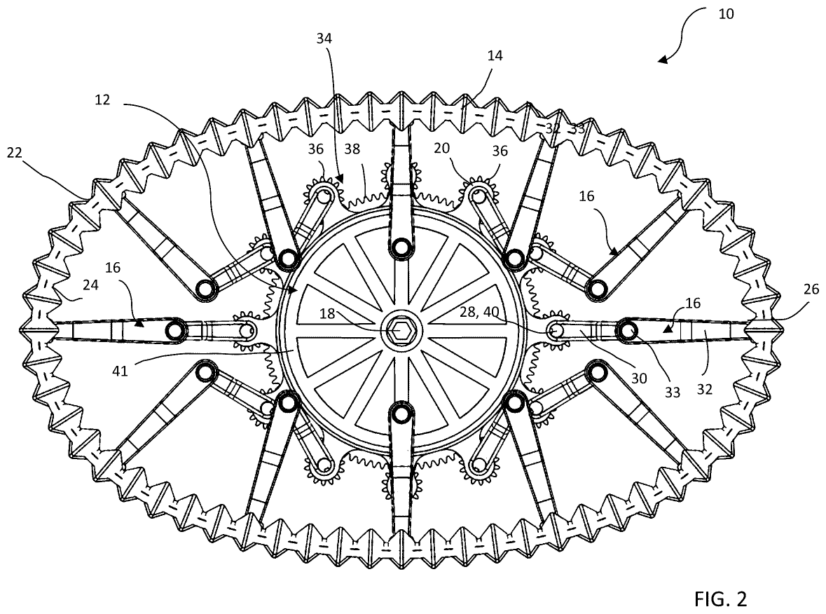

The hub 12 is provided with eyelets 20 at its periphery, which are used to mount the spokes 16 thereto. For example, the eyelets 20 are provided pairwise laterally spaced apart from each other, the pairs being substantially equidistantly spaced apart circumferentially relative to each other around the hub 12. However, other configurations of eyelets 20 are within the scope of the invention, with an example of such an alternative configuration being described below. The hub 12 illustrated in FIGS. 1 and 2 include twelve pairs of eyelets 20, but alternative hubs 12 having more than twelve or less than twelve eyelets 20 are within the scope of the invention.

The tread 14 surrounds the hub 12 spaced apart therefrom. The tread 14 defines a rolling surface 22 opposed to the hub 12 and an opposed inside surface 24 facing the hub 12. The rolling surface 22 may be corrugated, as seen in FIGS. 1 and 2. In alternative embodiments, the rolling surface 22 may be flat or present any other suitable texture. The exact configuration of the rolling surface 22 depends on the intended use of the wheel 10. The rolling surface 22 may include or be entirely made of rubber. In alternative embodiments (not shown in the drawings), the rolling surface 22 is provided with studs to improve traction on ice.

The tread 14 is deformable so that the inside surface 24 is radially movable relative to the hub 12 as the wheel 10 rotates, as further described below. To that effect, in some embodiments, the tread 14 is made entirely out of rubber, for example of a hollow piece of rubber, which may be pressurized or not. In alternative embodiments, the tread 14 may also include rigid portions articulated or otherwise linked to each other to allow deformation of the tread 14. In a specific embodiment, the tread 14 includes a track. While the tread 14 is relatively easy to bend in the plane of the wheel 10, the tread 14 is typically relatively rigid perpendicular to this direction, and is also relatively stiff circumferentially, so that the circumference of the wheel 10 remains substantially constant in use.

The spokes 16 extend between the hub 12 and the tread 14. Each spoke 16 is secured to the tread 14 at a respective tread-to-spoke attachment location 26 and to the hub 12 at a respective hub-to-spoke attachment location 28, which corresponds to the eyelets 20 in the embodiment shown in FIGS. 1 to 3. Accordingly, changing the number of eyelets 20 allows changes in the number of spokes 16 provided. Each spoke 16 is movable between a first configuration, wherein the respective tread-to-spoke attachment location 26 is closest to the respective hub-to-spoke attachment location 28, and a second configuration, wherein the respective tread-to-spoke attachment location 26 is furthest from the respective hub-to-spoke attachment location 28.

Referring for example to FIG. 2, using a clock oriented in the conventional orientation for reference, the spokes 16 located at 12 o'clock and 6 o'clock are in the first configuration, and the spokes 16 located at 3 o'clock and 9 o'clock are in the second configuration. The other spokes 16 are in configurations intermediate the first and second configurations.

The spokes 16 are configured and sized and operatively coupled to each other so that the tread 14 maintains a single predetermined elongated shape by varying a tread-to-hub distance between each of the pairs of respective tread-to-spoke and hub-to-spoke attachment locations 26 and 28 as the spokes 26 are moved between the spoke first and second configurations. This elongated shape is advantageous when moving on soft terrain, as it provides a relatively large surface area over which the weight of a vehicle can be distributed. For example, as the wheel 10 rolls on a horizontal surface, the spoke that is at 6 o'clock, and therefore in the first configuration, will move to the 9 or 3 o'clock position, depending on the direction of movement, and automatically achieve the second configuration, as all the other spokes adjust their configuration to maintain the predetermined shape. This shape is forced by the weight of the vehicle, which exerts a downward force, and therefore forces the spoke 16 that is a 6 o'clock to get shorter on horizontal ground. The other spokes 16 adopt their respective configurations in response to this constraint. If the wheel 10 meets an obstacle or an inclined surface, the net force exerted on the wheel by the terrain will have a non-vertical orientation, and the wheel 10 will therefore rotate relative to the horizontal, with its long axis tilting relative to the orientation adopted on a horizontal surface. However, due to the coupling between the spokes 16, the shape of the wheel 16 will remain the same.

In the embodiment of the invention shown in the drawings, the spokes 16 are articulated spokes each including a spoke hub segment 30 and a spoke tread segment 32. The spoke hub segment 30 is mounted to the hub 12 at the respective hub-to-spoke attachment location 28, which corresponds in the present embodiment to a respective eyelet 20. The spoke tread segment 32 is mounted to the tread 14 at the respective tread-to-spoke attachment location 26. The spoke hub and tread segments 30 and 32 are pivotally secured to each other through a pivot 33 opposed to the tread-to-spoke and hub-to-spoke attachment locations 26 and 28 to create an articulated spoke 16. In the embodiment shown in the drawings, the spokes 16 are provided in spoke 16 pairs laterally spaced apart from each other and linked to corresponding eyelet 20 pairs. Therefore, the wheel 10 includes two spokes 16 at each angular position around the tread 14. However, wheels 10 including more or less than two spokes 16 at each angular position around the tread 12 are possible in alternative embodiments. The spoke tread segment 32 is longer than the spoke hub segment 30, so that the pivot 33 is located radially inwardly relative to the hub-to-spoke attachment location 28 in the first configuration.

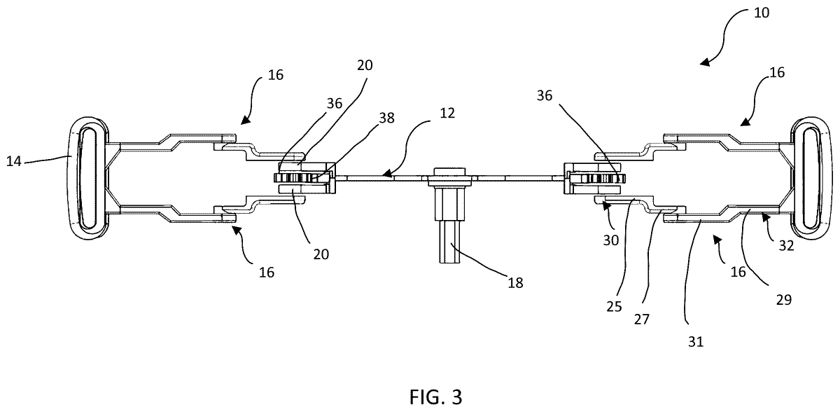

Referring to FIG. 3, in some embodiments, the spoke hub and tread segments 30 and 32 have a generally flattened Z-shaped configuration having respectively spoke hub inner and outer segments 25 and 27 and spoke tread inner and outer segments 29 and 31. The spoke hub inner and outer segments 25 and 27 extend longitudinally from each other, slightly laterally offset relative to each other with the spoke hub inner segment 25 laterally inwardly located relative to the spoke hub outer segment 27. Similarly, the spoke tread inner and outer segments 29 and 31 extend longitudinally from each other, slightly laterally offset relative to each other with the spoke tread inner segment 29 laterally inwardly located relative to the spoke tread outer segment 31. The spoke hub and tread inner segments 25 and 29 are secured respectively to the eyelets 20 and tread 14. The spoke hub and tread outer segments 27 and 31 are secured to each other, with the spoke tread outer segment 31 located outwardly relative to the spoke hub outer segment 27. When the spoke hub and tread inner and outer segments 25, 27, 29 and 31 are suitably sized, this allows the spoke tread segment 32 and spoke hub segment 30 to rotate over a full 360 degrees range around each other. However, in alternative embodiments, the spoke hub and tread segments 30 and 32 have any other suitable shape allowing them to rotate over a full rotation relative to each other.

Typically, the spoke hub segment 30 is pivotable relative to the hub 12, for example by being pivotable about the eyelet 20, and the spoke tread segment 32 is fixedly mounted to the tread 14, typically substantially perpendicular thereto. Bearings or bushings (not shown in the drawings) may be provided to facilitate rotation of the spoke hub segment 30 relative to the eyelet 20 and rotation of the spoke hub and tread segments 30 and 32 relative to each other.

Referring for example to FIG. 2, to ensure synchronized movements of the spokes 16 relative to each other, the wheel 10 includes a transmission 34 operatively coupling the spoke hub segments 30 of all the spokes 16 so that the spoke hub segments 30 maintain a predetermined relative angular relationship relative to each other as the spoke hub segments 30 rotate relative to the hub 12. In a specific embodiment, the transmission 34 includes a plurality of spoke gears 36 and a synchronizing gear 38. Each spoke gear 36 is jointly rotatable with the spoke hub segments 30 of a given pair of spokes 16. For example, the spoke gear 36 is mounted between the two eyelets 20 of each pair of eyelets 20 and a gear axle 40 couples the spoke gear 36 and the two spoke hub segments 30 that are mounted to each pair of eyelets 20 for joint rotation. The synchronizing gear 38 is provided around the hub 12 and is freely rotable therearound. The synchronizing gear 38 engages all the spoke gears 36 to synchronize rotation of the spoke gears 36 relative to each other, which in turn synchronizes rotation of all the spoke hub segments 30. In other embodiments, the rotation of the spoke hub segments 30 is synchronized in any other suitable manner, for example by a transmission including a chain, a belt or levers interconnecting the spoke hub segments 30 to each other, among other possibilities.

In the embodiment shown in the drawings, the eyelets 20 protrude radially outwardly from a hub central portion 41, and the synchronizing gear 38 surround the hub central portion 40 while being radially inwardly located relative to the spoke gears 36. Therefore, the spoke gears 36 support the synchronizing gear, as they surround the latter. Accordingly, the synchronizing gear 38 is not required to abut against the hub central portion 41. In some embodiments, the synchronizing gear may be supported by the hub central portion 41, optionally with bearings or bushings inserted between the hub central portion and the synchronizing gear. In another alternative embodiment, spoke gears 36 could define shoulders (not shown in the drawings) to support the synchronizing gear with shoulders.

Although not shown in the drawings, in some embodiments a resiliently deformable membrane extends across each side of the tread 14 to enclose the internal components of the wheel 10 to protect them from the environment.

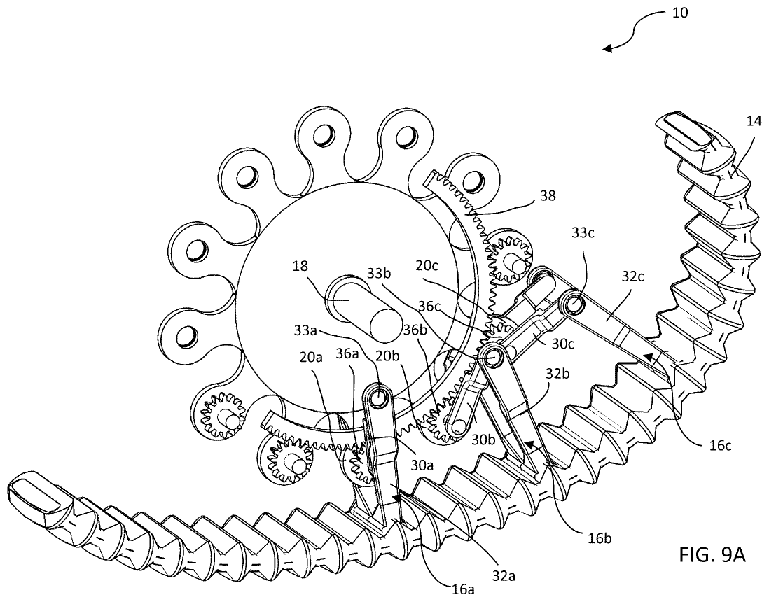

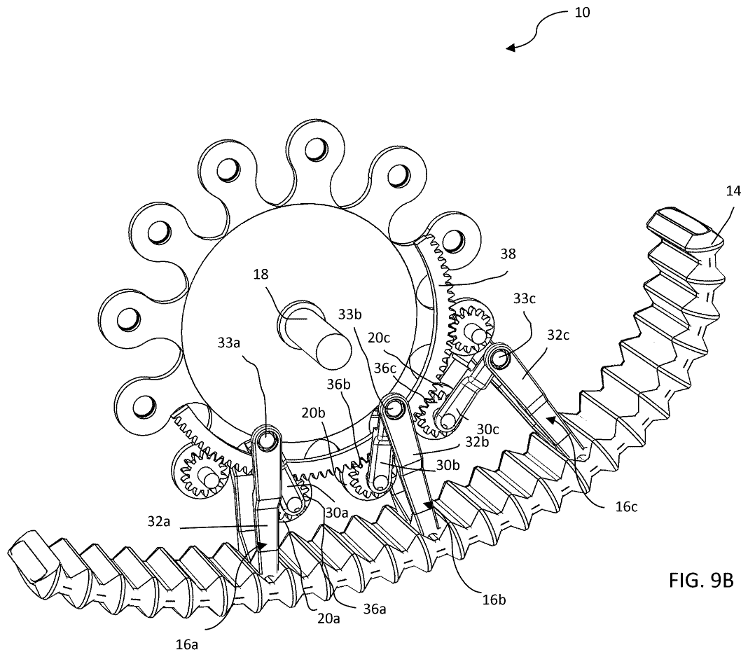

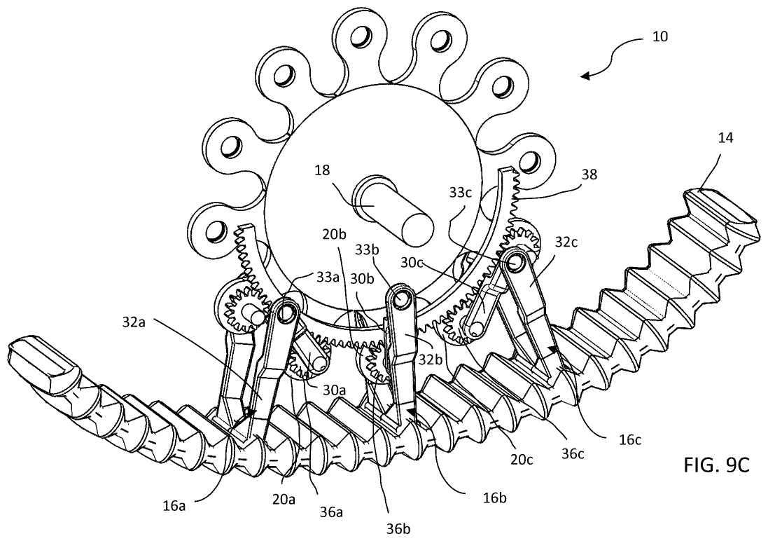

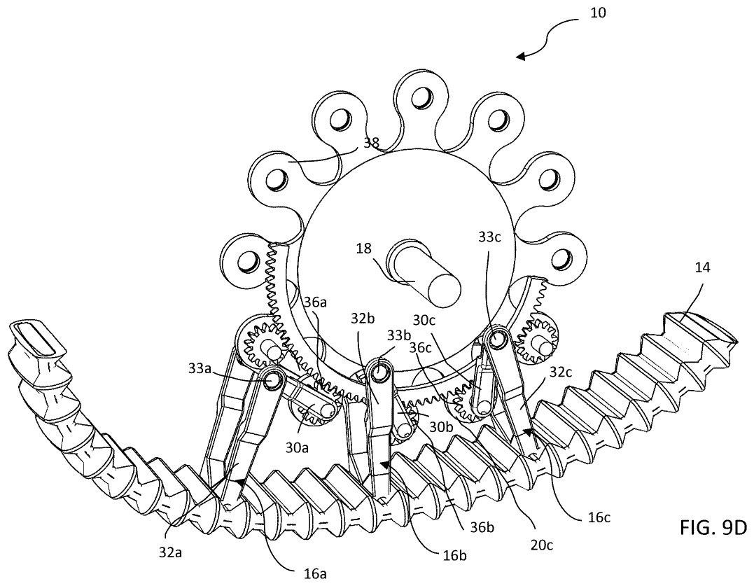

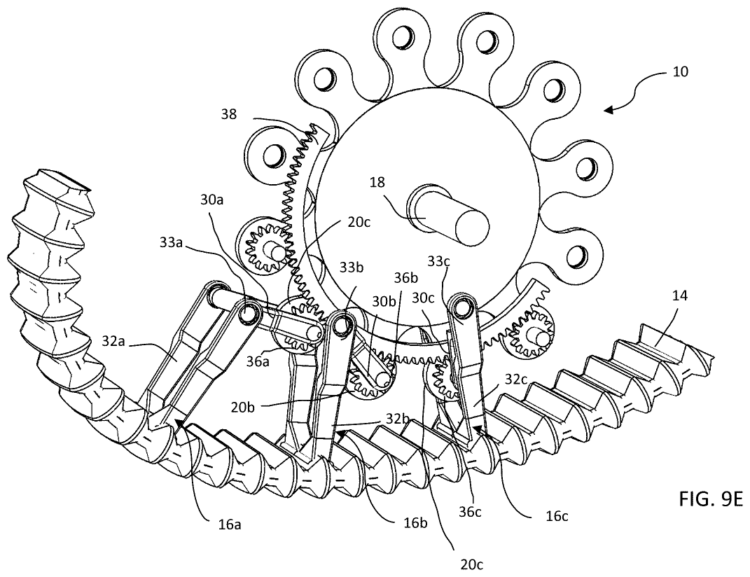

The sequence of FIGS. 9A to 9E illustrate how the movement of the spokes 16 is synchronized by focusing on the movement of 3 spokes 16, which are denoted by reference numerals 16a, 16c and 16c, over a small angular rotation of the wheel 10. In these figures, indices a to c are also appended to the reference numerals for the spoke gears 36a to 36c, eyelets 20a to 20c, pivots 33a to 33c and spoke hub and tread segments 30a to 30c and 32a to 32c, so that these parts can be distinguished from each other and tracked along the figure sequence. The wheel 10 may move either in response to rotation of the axle 18 through an external torque, or due to a translation of the axle 18 caused by movement of a vehicle to which the wheel 10 is mounted. In this example, the wheel 10 moves from left to right on level ground (not shown) as the figures progress from 9A to 9E.

In FIG. 9A, the axle 18 is vertically aligned with the eyelet 20a. This forces the eyelet 20a down, so that the spoke hub segment 30a extends upwardly from the eyelet 20a, towards the axle 18, which in turn positions the pivot 33a closest to the axle 18. The spoke tread segment 32a then extends vertically downwardly to reach the tread 14 at a location vertically aligned with the axle 18, so that the eyelet 20 can be closest to the ground. The angular position of all the other spoke hub segments is then set, due to the synchronizing gear 38 and the spoke gears 36, including spoke gears 36b and 36c shown in FIG. 9A, as the rotation of the spoke gear 36a causes a corresponding rotation of the other spoke gears 36, including spoke gears 36b and 36c. Once the spoke gears 36b and 36c achieve a given angular position, mechanical constraints caused by the spoke tread segments 32 and the tread 14 ensure that a single configuration of the wheel 10 is possible.

As the axle 18 is advanced towards the right, as seen in the sequence of FIGS. 9B to 9E, the spoke hub segments 30a to 30c are rotated counterclockwise. If the axle 18 is driven, this rotation is caused by a clockwise torque exerted by the axle, which create a force directed towards the left on the eyelets 20a to 20c. If friction between the hub 12 and the ground is large enough, the latter will remain fixed and this force will cause a reaction force that will move the axle 18 towards the right. If the axle 18 is not driven, the movement towards the right is simply created by a movement towards the right of a vehicle to which the wheel 10 is mounted.

As the axle 18 moves towards the right, the eyelets 20a to 20c move clockwise, and the eyelets 20b and 20c sequentially occupy the position that was previously occupied by the eyelet 20a, as seen respectively in FIGS. 9C and 9E. This cause deformation of the tread 14 and movements of the spoke tread segments 32 to preserve the shape of the tread 14, due to the same force transmission that was described hereinabove. Therefore, the wheel 10 advances while preserving a substantially constant shape. If the direction of the force exerted by the axle changes, for example due to obstacles or to inclined terrain, the wheel will preserve the same shape, but rotated relative to the horizontal, so that its shortest diameter remains aligned with the net force exerted by the axle 18.

While a specific version of the wheel 10 has been described hereinabove, many variants operating along similar principles are possible. A few examples of such variants are described hereinbelow, with only the difference between these variants and the wheel 10 being described in details.

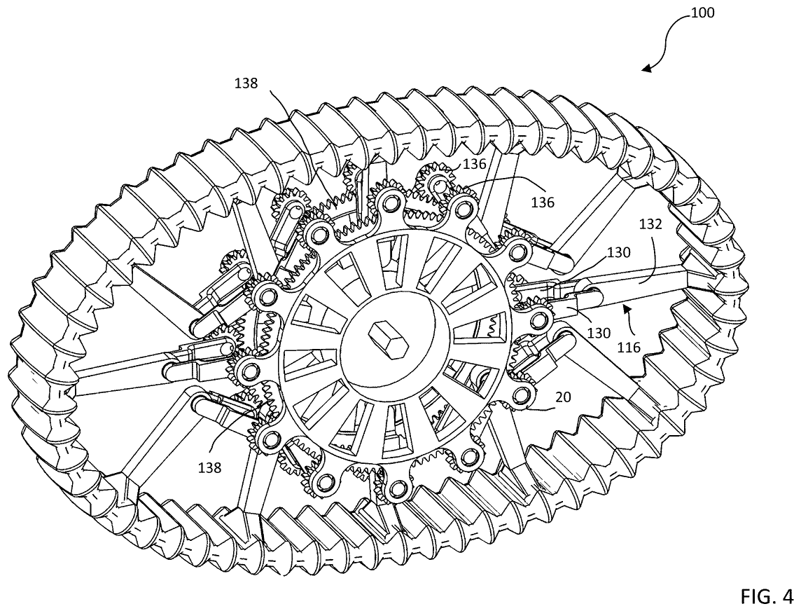

FIG. 4 illustrates a wheel 100 in which each spoke 116 includes two laterally spaced apart spoke hub segments 130, each mounted to a respective eyelet 20 from each pair of eyelets, and each jointly rotatable with a respective spoke gear 136. The two spoke hub segments 130 are each pivotally mounted to a single spoke tread segment 132, and two synchronizing gears 138 are provided laterally spaced apart from each other.

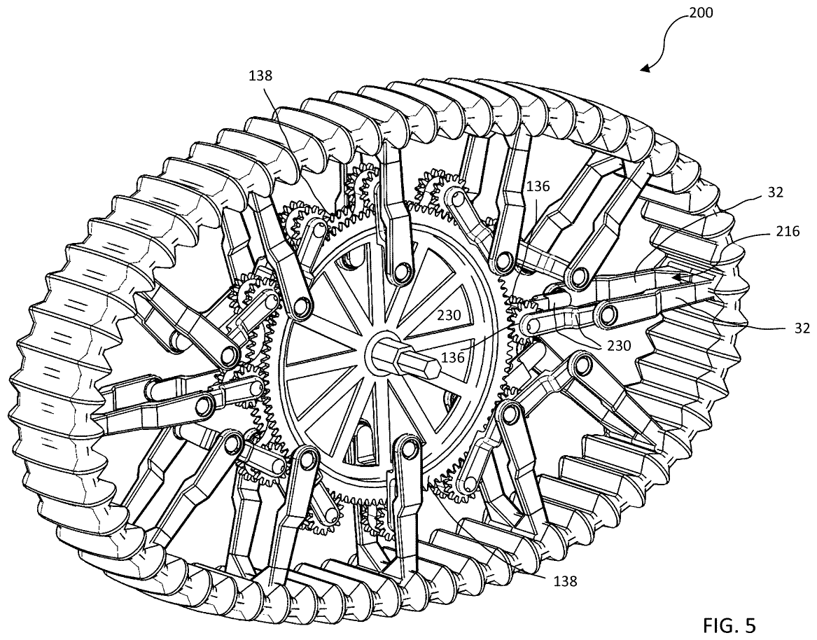

The wheel 200 shown in FIG. 5 is similar to the wheel 10, except for the hub eyelets 20 that are centralized and not in pairs laterally. However, the wheel 200 is provided with two synchronizing gears 138 and each spoke hub segment 230 of each spoke 216 is coupled to a pair of spoke gears 136, as in the wheel 100.

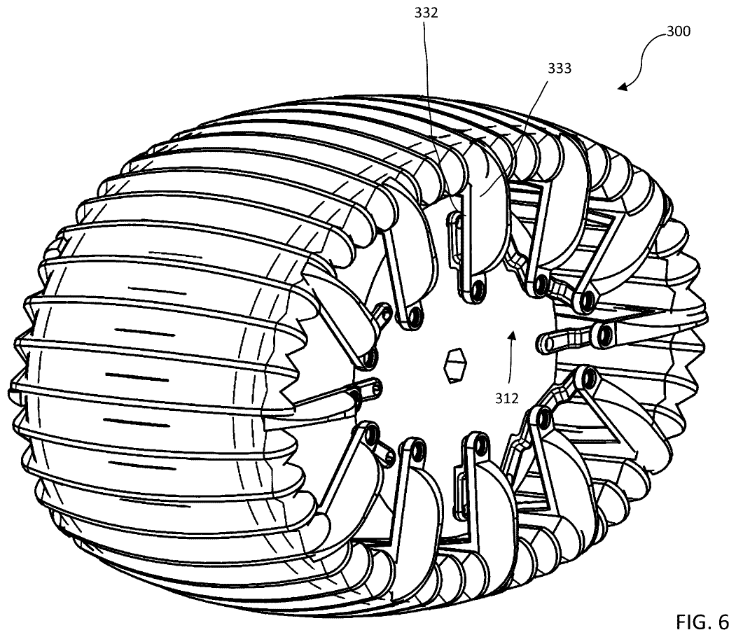

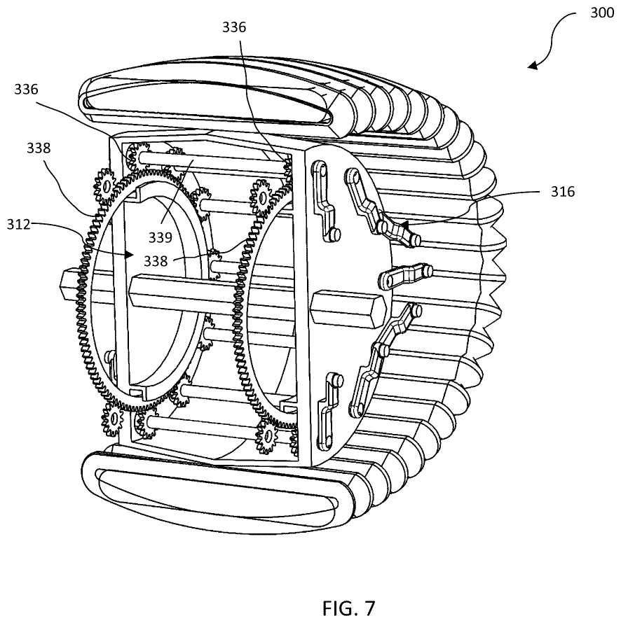

FIGS. 6 and 7 collectively illustrate yet another wheel 300 in which the hub 312 is hollow and hermetically closed so that the wheel 300 is buoyant. In such embodiments, an amphibious vehicle can be created, when the buoyancy of the wheel 300 is sufficient and a vehicle to which the wheel 300 is mounted is adapted to enter water without damage. In such embodiments, it my be advantageous for the wheel 300 to define paddles for pushing against water when the wheel 300 is partially immersed in the water. Such paddles may be for example created by fins 333 extending laterally outwardly from the spoke tread segments 332.

As seen in FIG. 7, in these embodiments, the synchronizing and spoke gears 336 and 338 are located inside the hub 312, and spokes 316 are locate outside the hub 312. An axle 339 extends through the hub outer walls between the spokes 316 and the spoke gears 336, with a suitable seal provided to prevent water from entering inside the hub 312.

In yet other embodiments, the wheel 400 itself includes an electric motor. For example, the synchronizing gear 438 is motorized such that rotating the synchronizing gear 438 relative to the hub 412 rotates the spoke hub segments 430 relative to the hub 412 to entrain the wheel 400. For example, the synchronizing gear 438 is provided with coils or magnets 450 and form a rotor of an electric motor, and the hub 412 is provided with coils 452 and form a stator of the electric motor. By suitably activating the coils 450 and/or 452 using standard sequences, the synchronizing gear 438 can be rotated to entrain the wheel 400.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is

1. A deformable wheel, comprising:
a hub;
a deformable tread surrounding the hub spaced apart therefrom; and
a plurality of spokes extending between the hub and the tread, each spoke being secured to the tread at a respective tread-to-spoke attachment location and to the hub at a respective hub-to-spoke attachment location, each spoke being movable between a first configuration wherein the respective tread-to-spoke attachment location is closest to the respective hub-to-spoke attachment location and a second configuration wherein the respective tread-to-spoke attachment location is furthest from the respective hub-to-spoke attachment location;
wherein the spokes are configured and sized and operatively coupled to each other so that the tread maintains a single predetermined elongated shape by varying a tread-to-hub distance between each of the pairs of respective tread-to-spoke and hub-to-spoke attachment locations as the spokes are moved between the spoke first and second configurations.

2. The wheel as defined in claim 1, wherein the spokes each include a spoke hub segment mounted to the hub at the respective hub-to-spoke attachment location and a spoke tread segment mounted to the tread at the respective tread-to-spoke attachment location, the spoke hub and tread segments being pivotally secured to each other through a pivot opposed to the tread-to-spoke and hub-to-spoke attachment locations.

3. The wheel as defined in claim 2, wherein the spoke hub segment is pivotable relative to the hub and the spoke tread segment is fixedly mounted to the tread.

4. The wheel as defined in claim 3, wherein the spoke tread segment is substantially perpendicular to the tread.

5. The wheel as defined in claim 3, further comprising a transmission operatively coupling to each other the spoke hub segments of all the spokes so that the spoke hub segments maintain a predetermined relative angular relationship relative to each other as the spoke hub segments rotate relative to the hub.

6. The wheel as defined in claim 5, wherein the transmission includes a plurality of spoke gears each jointly rotatable with a respective one of the spoke hub segments and a synchronizing gear engaging all the spoke gears to synchronize rotations of the spoke gears relative to each other.

7. The wheel as defined in claim 6, wherein the synchronizing gear is freely rotatable around the hub.

8. The wheel as defined in claim 6, wherein the synchronizing gear is motorized such that rotating the synchronizing gear relative to the hub rotates the spoke hub segments relative to the hub to entrain the wheel.

9. The wheel as defined in claim 8, wherein the synchronizing gear is part of a rotor of an electric motor and the hub is part of a stator of the electric motor.

10. The wheel as defined in claim 2, wherein the spoke tread segment is longer than the spoke hub segment.

11. The wheel as defined in claim 2, wherein the pivot is located radially inwardly relative to the hub-to-spoke attachment location in the first configuration.

12. The wheel as defined in claim 2, wherein the pivot is located radially outwardly relative to the hub-to-spoke attachment location in the second configuration.

13. The wheel as defined in claim 1, wherein the tread includes a track.

14. The wheel as defined in claim 1, wherein the tread includes a rubber outer surface.

15. The wheel as defined in claim 14, wherein the rubber outer surface is corrugated.

16. The wheel as defined in claim 1, wherein the tread is made of rubber.

17. The wheel as defined in claim 1, wherein the hub is hollow and hermetically closed so that the wheel is buoyant.

18. The wheel as defined in claim 17, wherein the wheel defines paddles for pushing against water when the wheel is immersed in the water to advance the wheel.

19. A deformable wheel, comprising:
a hub;
a deformable tread surrounding the hub spaced apart therefrom; and
a plurality of spokes extending between the hub and the tread, each spoke being secured to the tread at a respective tread-to-spoke attachment location and to the hub at a respective hub-to-spoke attachment location, each spoke being movable between a first configuration wherein the respective tread-to-spoke attachment location is closest to the respective hub-to-spoke attachment location and a second configuration wherein the respective tread-to-spoke attachment location is furthest from the respective hub-to-spoke attachment location;
wherein the spokes are configured and sized and mechanically coupled to each other so that the tread maintains a single predetermined elongated shape when the wheel advances on a ground surface.
